(19) United States
(12) Patent Application Publication
(10) Pub. No.: US 2006/0247943 A1
(43) Pub. Date: Nov. 2, 2006

(54) System and method for generating and evaluating an innovation

(75) Inventor: Alok Kapoor, Boston, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Millennium Ventures Group, Boston, MA (US)

(21) Appl. No.: 11/119,520

(22) Filed: Apr. 29, 2005

(51) Int. Cl. G06Q 99/00

(52) U.S. Cl. 705/1

(57) ABSTRACT

A method for systematically generating and evaluating an innovation. The method includes identifying and selecting an entrepreneurial opportunity. The method also includes conceptualizing the entrepreneurial opportunity into a plurality of potential products and distributing an economic risk. The economic risk is associated with the opportunity. The method also includes envisioning an organization for introducing products and pursing the opportunity.

### BACKGROUND OF THE INVENTION

Most inventors invent using an arbitrary “Eureka” approach, i.e. by momentary and random insights. In addition, it is not always clear which inventions will be adopted. For example, in the United States, it has been estimated that as many as 3,000 to 5,000 new concepts yield one useful product. While many concepts are generated, few of them actually become innovative products; and even fewer of these products succeed in the marketplace. Statistically, corporations waste more than three-fourths of their resources in futile endeavors.

Thus, a systematic approach for generating innovative products and services could reduce inefficiencies and increase the overall production.

### SUMMARY OF THE INVENTION

The present invention provides methods and apparatus, including computer programs, for systematically generating innovation.

In one aspect, the invention features methods that include the steps of identifying and selecting a new opportunity; conceptualizing a plurality of potential products that captures the opportunity. The method also includes distributing economic risk. The economic risk is associated with the opportunity. In addition, the method includes envisioning an organization for introducing the potential products and pursuing the opportunity.

In another aspect the invention features a computer program that is tangibly embodied in an information carrier. The computer program is operable to cause a data processing apparatus, in a network of interconnected computers, to identify and select a new opportunity. The computer program also conceptualizes the new opportunity into a plurality of potential products. In addition, the computer program distributes an economic risk. The economic risk is associated with the opportunity. The computer program also envisions an organization for introducing the potential and pursuing the opportunity.

Yet another aspect of the invention features an apparatus that includes a system that provides means for identifying and means for selecting a new opportunity. The system also provides means for conceptualizing the new opportunity into a plurality of potential products. In addition, the system also provides means for distributing an economic risk. The economic risk is associated with the opportunity. The system also provides means for envisioning an organization for introducing the potential products and pursuing the opportunity.

Any of the above aspects may include one ore more of the following features. In one implementation, the method further comprises mitigating a future risk for the opportunity. The method includes identifying a future risk, assigning an innovation index number to the future risk and prioritizing the future risk into a priority order. The priority order is allocated according to the innovation index number. The method also includes resolving each future risk according to the priority order. The innovation index number may be used by a business entity for evaluating a plurality of intellectual property assets. The innovation index also may be used by a policy-making entity for evaluating economic health for a selected community. The potential product is a good or a service. The opportunity is an unexplored opportunity in the marketplace, where the marketplace is a selected community.

In another implementation, the method for selecting a new opportunity further includes the steps of identifying plurality of innovative dispositions of a client thereby generating a client profile. The innovative dispositions include a plurality of innovative strengths and a plurality of innovative weaknesses. Identifying the plurality of innovative dispositions includes administering personal diagnostics. The personal diagnostics is used to test a level of critical awareness, which is selected from a group consisting of ethics, physical action, analytical reasoning, creative imagination, emotion, memory, motivation, perception and sensation. The client may be an individual, an organization, or an investor. The method also includes the step of identifying a plurality of institutional influences. In addition, the method also includes identifying a plurality of societal needs by aggregating a plurality of sectors. The sectors are selected from a group consisting of food, shelter, clothing, education, entertainment/communications, transportation, energy, healthcare, safety, hope, entertainment, transportation, energy, healthcare, safety, relationship and money. The societal need may be customized according to a demographic. The method also includes comparing the identified societal needs with the client profile. The new opportunity is selected where the specific societal need that matches the greatest number of innovative strengths and least number of negative institutional influences. The method may be performed on a computer.

In another implementation, the method for conceptualizing the new opportunity includes generating a potential product and a corresponding competitive comparison. To generate the potential product includes the steps of: generating a successful features list; manipulating the successful features in an unique feature; applying the unique feature to an new opportunity and generating the potential product and the corresponding competitive comparison. Generating a successful features list includes identifying a plurality of related pre-existing products; examining the related pre-existing product for successful features; and adding the successful features to the features list. The method also includes manipulating the successful features into an unique feature; applying the unique feature to an new opportunity; and generating a potential product. Manipulation of the successful features may include combining several successful features to generate an unique feature; generating a simplified version of the successful feature; generating a smaller version of the successful feature; and adding an improvement to the successful feature. An improvement may be a feature that enhances the performance of the related pre-existing product. Manipulation may also include lowering an expense associated with the pre-existing product and ensuring that the unique feature and successful feature share a foothold with a consumer. The method for conceptualizing the potential product also includes prioritizing the potential product in a production order. The production order is a sequential ranking of when the potential product is introduced in the market. In addition, the method includes protecting an intellectual property right of the potential product.

In yet another implementation, the method of distributing the economic risk includes evaluating a plurality of risks within a selected community. The evaluating includes selecting a country for marketing a plurality of potential products. The potential products are associated with the opportunity. The evaluating also includes retrieving an economic profile for the selected community from an external database; and comparing the potential products with the economic profile for the selected community. In addition, the evaluating includes identifying the economic risk for the selected community. The method of distributing economic risk also includes diversifying a plurality of economic components; exploring a plurality of financial vehicles; and distributing a plurality of economic responsibilities.

Still another implementation includes a method for envisioning an organization for introducing products and pursing the opportunity. The method includes identifying a business process for generating a revenue and managing a cost; generating the organization procedures that correspond to the business process; and assigning a worker to implement the organizational procedure. The method also may include reorienting the opportunity. The method for assigning a worker to implement the procedures may include identifying a plurality of workers within a particular geographical location and assigning a required level of stewardship and skill for each organization procedure. The level of stewardship can measure a plurality of positive character traits associated with a workplace environment. The method can also include interviewing each worker to determine is a level of stewardship and skill; matching a qualified worker to each organization procedure based on a comparison between the level of stewardship and skill and the required level of stewardship and skill; and assigning a compensation to the worker, the compensation can be commensurate to the level of stewardship and skill of the worker and the allocated procedure. Compensations include benefits, wages and stock ownership options.

Further features and advantages of the instant disclosed methods and systems will become more apparent from the following Drawings, Detailed Description and Claims.

### BRIEF DESCRIPTION OF THE DRAWINGS

FIG. 1 is a flow diagram of a process for managing innovation;

FIG. 2 provides an overview of a client generating an innovation;

FIG. 3 is a flow diagram of a process for selecting a new opportunity;

FIG. 4 is a flow diagram of a process for conceptualizing a portfolio of product(s);

FIG. 5 is a flow diagram of a process for distributing economic risk;

FIG. 6 is a flow diagram of a process for executing the new opportunity;

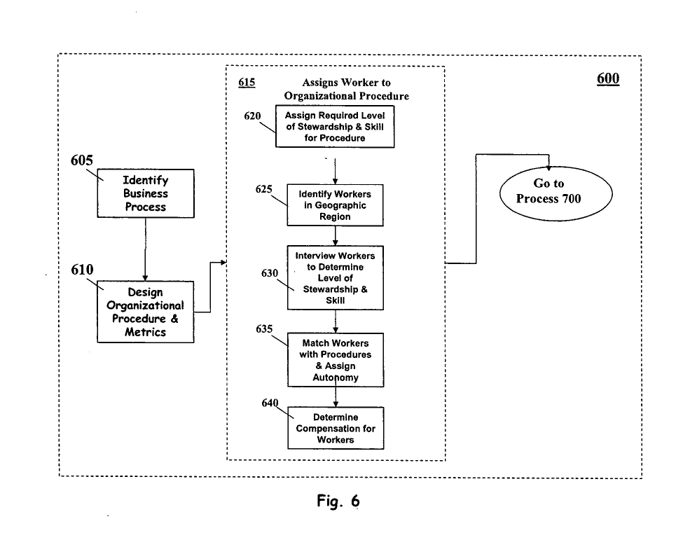

FIG. 7 is a flow diagram of a process for mitigating risks.

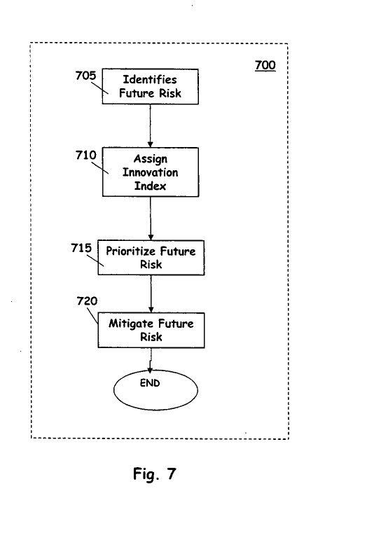

### GENERAL

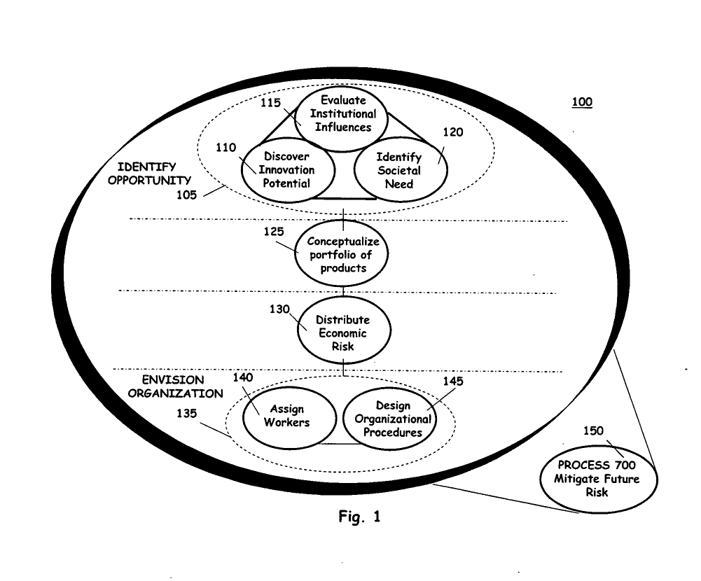

FIG. 1 is a flow diagram of process 100, which describes the steps for managing innovation.

Process 100 distills a unique and sustainable venture proposition by identifying (105) new opportunities and conceptualizing (125) the new opportunities into a portfolio of product(s). In order to avoid failure and improve the chances for success, a client selects a venture proposition, or new opportunity, based upon her innovation potential, the societal needs, and the impact of various institutions. In this regard, process 100 discovers (110) the innovation potential for a client through various testing mechanisms. Process 100 also evaluates (115) institutional influences and identifies (120) societal needs.

After identifying (105) the opportunity, process 100 conceptualizes (125) a portfolio of product(s). Process 100 then distributes (130) the economic risk by diversifying the product amongst markets and economic components, exploring alternative financial vehicles, and distributing responsibilities across the supply chain management. Distribution (130) of economic risk increases the product's success within the selected marketplace.

Process 100 envisions (135) an organization that would execute the new opportunity by designing (140) organizational procedures and assigning (145) qualified workers to implement these procedures. Finally, process 100 examines the new opportunity for future risks and mitigates (150) these future risks.

In one embodiment, the client is an individual innovator or a business entity that wishes to generate innovation. However, in another embodiment, the client is an investment decision-maker who wishes to evaluate a potential investment. In yet another embodiment, the client is a corporation, or any entity, that wishes to reorient an existing concept. Reorientation refers to a reevaluation of an original concept by tracking its evolution and current status within the marketplace. The client uses the information to determine, among many things, future activities.

### DEFINITIONS

For convenience, the meaning of certain terms and phrases employed in the detailed description and claims are provided below. Unless defined otherwise, all technical and scientific terms used herein have the same meaning as commonly understood by one of ordinary skill in the art.

### TERM DEFINITION

business entity: A group of people with a shared business or vision. A business entity includes for profit and not-for-profit organizations.
capital: Money or goods that are devoted to the production of other goods.
capital-generating entity: An entity, e.g. individual or business which provides capital to innovators for expenditures. Examples include consumers, government institutions, corporations, venture capitalists, or private sources of money.
client: An entity, e.g. an entrepreneur or other individual or entity interested in evaluating a new opportunity (e.g. a potential investor).
community: An interactive population of various kinds of individuals living in a common location. Examples of community include a group, a state, or a country.
concept: A set of decisions that determine future actions. A concept eventually takes a form of a product and is then available for use.
critical awareness: A set of personality traits involved with creating or developing an innovation or exploring an new opportunity, including ethics, physical action, analytical reasoning, creative imagination, emotion, memory, motivation, perception, and sensation.
demographics: Statistics for human populations, especially with reference to size and density, distribution, and vital statistics (e.g. age groups; racial classes; disposable incomes; and spending power).
economic obstacle: An impediment to progress or achievement of an innovation. Examples include impediments in the area of efficiency of money flow, components of economy, financial infrastructure and economic incentives of collaborators.
economic profile: Information pertaining to the macro-economic environment of a market, such as the overall efficiency of money flow, the consumer spending trends, the business investment trends, the government spending trends, and the various trade balance trends.
entrepreneur: Individual pursuing innovation outside of a pre-established organization.
expenditures: The expenses and disbursements for generating, manufacturing, marketing, and selling an innovative product. Examples of these expenses include employee salaries, personal debts, taxes, corporate debts, profits, and dividends to shareholders.
foothold: Observations to determine what a consumer would implement. Some areas that are observed include: interdependence, knowledge sharing, protection, time reallocation, etc . . .
innovation: A unique and potentially useful product for an identified opportunity.
innovation diagnostic: Any method or test that evaluates innovative strengths and weaknesses. Examples include psychological tests, aptitude tests, and human-metrics examinations such as the Jung-Meyers-Brigg test.
innovative strengths: A talent or asset of an innovator, including expertise in a particular market, a skill, a networking alliance, and a level of a critical awareness.
institution: A significant practice, relationship, or organization in a society or culture that impacts the economic future of a proposed innovative opportunity. Examples include science, technology, government, religion, social welfare, aesthetic trends and business.
institutional profile: Information pertaining to trends that occur within an institution.
interview: A formal consultation to evaluate the qualifications of a worker.
intrapreneur: Individual pursuing innovation within an pre-established organization.
macro-economic environment: Economic activities of a market, e.g. a country.
market or marketplace: An environment into which a new opportunity is introduced, for example a selected community, or institution.
market industries: A distinct group of productive or profit-making enterprises, such as retail, sports and entertainment, food, healthcare, medical and high-tech.
networking: An exchange of information or services among individuals, groups, or institutions.
networking alliance: A group of individuals or organizations providing networking opportunities, such as friends, family members, and colleagues.
obstacles list: A listing of potential impediments to adoption of an innovation.
opportunity: An area of potential innovation or an unexploited need in a market.
organizational procedures: A set of concrete actions items which can be implemented to enable a business process.
personal diagnostic(s): Test(s) which can be administered to determine an innovator's innovative strengths, examples include: personality, skills and aptitude tests.
product: A good or service.
reorient or reorienting To readdress the innovation for new opportunities or new products, includes strategizing about pre-existing technologies, exploring synergy within various sectors (e.g. mergers & acquisitions, IPO), etc . . .
skill: A learned power of doing something competently; a developed aptitude or ability, such as a language ability, education and expertise in a particular area or technology; interpersonal skills.
stewardship qualities: Character qualities for a particular worker. Examples include a sense of loyalty, a set of work-ethics, customer orientation and a level of self-motivation.
societal diagnostic tool: A test which can be useful for determining a societal need. Examples include a needs matrix, an opportunity sizing table, and a product development map. A societal diagnostic tool can be customized for a particular country.
societal need: A lack of something desirable or useful in society, such as food, shelter, clothing, education, entertainment, transportation, energy, healthcare, safety, hope, communications and money.
trend: A general movement in the course of time of a statistically detectable change.
worker: An individual within or external to a company.

### DETAILED DESCRIPTION OF AN ILLUSTRATIVE EMBODIMENT

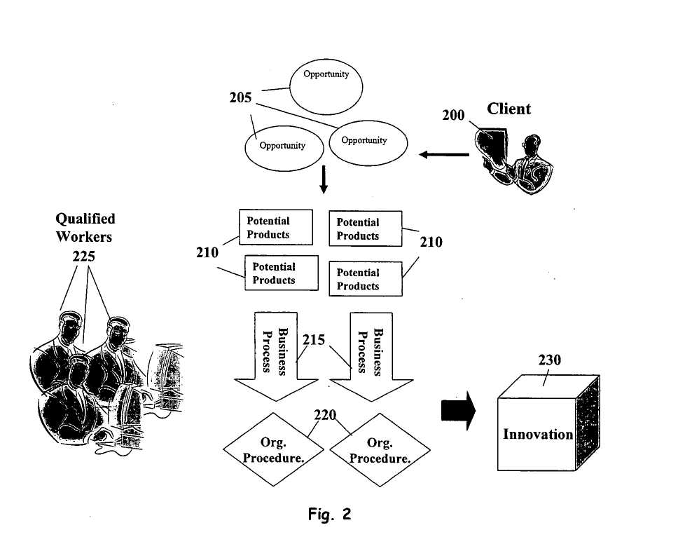

As shown in FIG. 2, client 200, an entity who is interested in managing a potential innovation, selects a new opportunity 205 and conceptualizes the new opportunity 205 into potential product(s) 210. The products 210 are scrutinized for economic risks. These risks are distributed in various venues. Client 200 then identifies the business processes 215 needed for executing the new opportunity 205. She designs corresponding organizational procedures 220 and assigns potential qualified workers 225 who would carry out these procedures 220. Execution of all such procedures in the future generates a successful innovation 230.

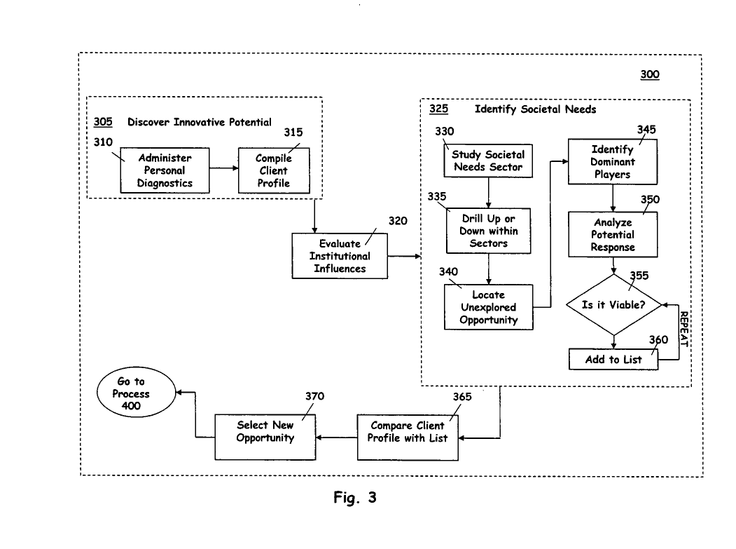

FIG. 3 illustrates process 300, which selects a new opportunity to define the venture proposition 205. Sub-process 305 discovers the innovative disposition of a new client 200 by administering (310) a number of personal diagnostics. The results from the client diagnostics are compiled (315) into a client profile, which is a summary of the client's innovative strengths and weaknesses. The client profile may be generated electronically, or in paper form. Innovative strengths include both tangible and intangible assets of client 200, such as a specialized expertise or skill, a personal interest, psychological make-up, networking alliances, and a level of critical awareness. Critical awareness describes the set of personality traits that impact the client's ability to create and develop a new opportunity 205. These may include ethics, physical action, analytical reasoning, creative imagination, emotion, memory, motivation, perception, and sensation.

Personal diagnostics may be conducted electronically via software products, or in-person through an interactive workshop. Examples of personal diagnostics include psychological or humanmetric tests, such as the Jung-Meyers-Brigg personality exam. The diagnostics evaluate, among many things, an entrepreneur's or intrapreneur's ability to recover from rejection; decision-making capabilities (e.g. logical reasoning, emotional influence); and flexibility towards alternatives and new ideas. Other personal diagnostics measure technical and behavioral skills, e.g. area of expertise, language proficiency, or communication skills. Still other diagnostics evaluate networking alliances, which represent the subset of individuals with whom the client 200 can interact to supplement personal deficiencies. Each networking alliance is assessed for the ability to help advance the new opportunity 205.

A new client 200 uses the client profile to identify areas of strengths and weaknesses. For example, if an entrepreneur or intrapreneur 200 has a small networking alliance, the number of alliances could purposefully be increased, e.g. by attending certain conferences. By empowering a new client 200 with a deeper understanding of personal strengths and weaknesses, sub-process 300 allows the entrepreneur to properly focus resources and energy in areas yielding highest returns and to bring in supplementary skill sets where needed.

Process 300 also evaluates (320) the impact of various macro-societal institutions on each unexplored opportunity. An institution represents several organizations that share a macro-societal purpose. Examples of institutions include science, technology, government, religion, social welfare, art & aesthetics, and business. For example, negative publicity on child-laborers, knowledge about environmentally harmful materials, or significant litigation in a particular business field, all constitute institutional influences. A study of institutional influences provides context for unexplored opportunities. Client 200 stays abreast of the latest findings in all institutions. New scientific findings could lead to new technologies. New technologies could lead to formation of new businesses. New regulation could block business formation or scientific research.

As shown in FIG. 3, process 300 also identifies societal needs using sub-process 325, which studies (330) the various sectors of societal needs in order to determine unexplored opportunities. A societal need is a lack of something desirable or useful in a society, such as food, shelter, clothing, education, entertainment, transportation, energy, healthcare, safety, hope, communications and money. Each sector is associated with a societal need studied by referring to habits and trends of consumers and producers. A sector also aggregates related goods and services according to various levels of detail. For example, the transportation sector includes the airline, automobile and railway.

Client 200 may “drill down” from a selected sector into sub-categories. Drilling down is a term of art which means to narrow a category into more specialized sub-categories. Client 200 also may expand the sub-categories by “drilling-up.” In the transportation example mentioned above, the client 200 drills down (335) from the transportation sector into sub-categories of airline, automobile, and railway. She further drills down (335) from the airline into sub-categories of private charters, transcontinental, regional and national. Sub-process 325 continues drilling up and down (335) within the sector categories until the entrepreneur locates (330) an unexplored opportunity.

An unexplored opportunity can be formulated by identifying a pent-up, or emerging societal need, that has no corresponding good or service available in the producer landscape. The unexplored opportunity can also be an available good or service, but with applicability to a wider audience or in a different sector. For example, the introduction of automobiles into China illustrates the transference of an available good into a previously unexplored audience. Likewise, the shift from using airplanes solely for military defense (safety sector) to private leisure travel (transportation sector) exemplifies applying an available good to a new sector.

After locating (340) an unexplored opportunity, sub-process 325 “sizes” the opportunity by considering its viability (i.e. will it survive in the marketplace). In this regard, sub-process 325 identifies (345) the dominant players, or established competitors in the sector, and analyzes (350) the potential responses by these players. For instance, dominant players may respond positively by licensing or buying the unexplored opportunity; or they may respond negatively by under-pricing or blocking or imitating market entry by the entrepreneur or intrapreneur 200. An unexplored opportunity is considered (355) “viable” whenever the quantity of positive responses outnumber the quantity of negative responses. Viable opportunities are added (360) to a list of potential opportunities.

However, if the unexplored opportunity is considered (355) inviable, then sub-process 325 returns to studying (3330) the societal needs sectors in order to find another unexplored opportunity.

Process 300 then compares (365) the client profile with the list of potential opportunities. Process 300 selects (370), a new opportunity 205, by choosing an opportunity that corresponds to the greatest number of innovative strengths and least number of negative institutional influences.

In some embodiments, sub-process 325 identifies the societal needs before sub-process 305 and step 320 discover the client's innovative strengths and evaluate institutional influences, respectively. In another embodiment, sub-process 305, step 320, and sub-process 325 occur simultaneously.

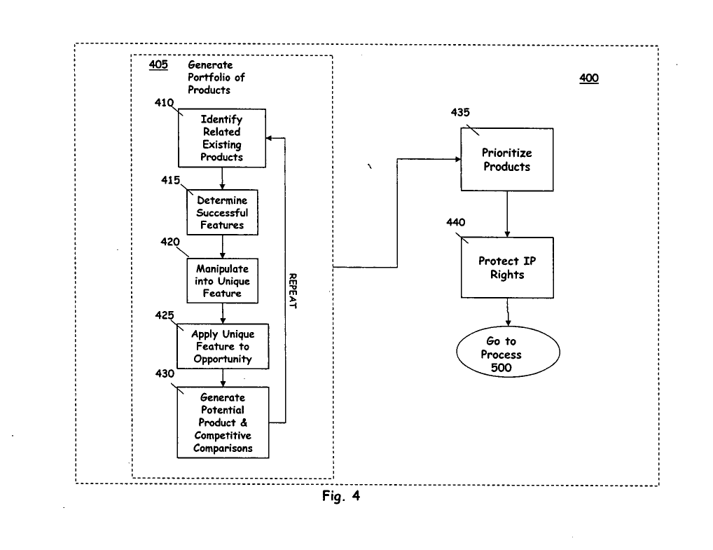

After the selection (370) of a new opportunity 205, process 400 (FIG. 4) conceptualizes the selected new opportunity 205 into a portfolio of product(s) 210. To this end, process 400 generates potential product(s) using sub-process 405. Sub-process 405 identifies (410) a group of related existing products. These related products share similar features and characteristics to the new opportunity 205. Each related pre-existing product is examined in order to determine (415) the successful feature(s) that contributed to the product's success.

Sub-process 405 manipulates (420) the successful feature(s) into unique feature(s) and applies (425) the unique features to new opportunity 205 in order to generate (430) a potential product with competitive comparisons. Sub-process 405 manipulates (420) the successful feature(s) using a medley of manipulation techniques, such as combining several successful features; generating a simplified version of the successful feature; generating a smaller version; adding an improvement to the successful feature; lowering expenses associated with the pre-existing product; and ensuring that the unique feature and successful feature share a foothold with a consumer. A foothold related to whether a consumer will use the potential product. By repeating sub-process 405, process 400 explores the full extent of new opportunity 205, which results in a portfolio of potential product(s).

Process 400 prioritizes (435) the products according to their order of production. Process 400 also seeks to protect (440) the intellectual property rights of the product, e.g. applying for patents, trade dress, trademarks and copyrights. In some embodiments, the product phasing, or the amount of required manufacture time, affects the prioritizing (435). For example, a product that takes twenty years to manufacture receives a lower production order (lower priority) than a product with a faster turn-around time.

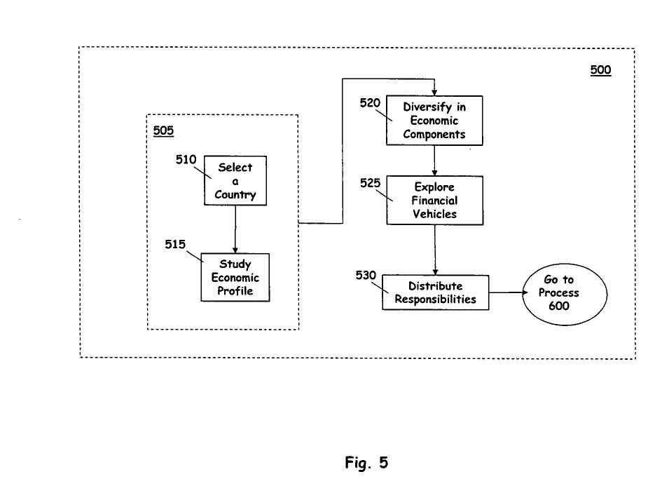

As shown in FIG. 5, process 500 distributes economic risk for the new opportunity 205. Process 500 evaluates the risks within a particular country using sub-process 505. Sub-process 505 selects (510) a country and studies (515) the corresponding economic profile for that selected community. The economic profile may be retrieved from an external data-source, which is updated continuously. The economic profile contains information regarding the macro-economic environment for the selected community. Macro-economic features include the economic activities of the country, as well as the interplay of several factors, such political stability, trade regulations, and economic infrastructure. In particular, the economic profile illustrates the flow of money within the country (e.g. the chief sources of money; largest expenditures).

For example, client 200 decides to develop her products in the United States. While reviewing the economic profile for the U.S., she learns that the United States is experiencing an inflated market, which foreshadows a slowdown in the near future. Since a slowdown detrimentally affects the number of business investments, the client 200 decides to diversify (520) within several economic components, or categories of potential buyers. Economic components may include business spending, consumer spending, government spending and trade. In the previous example, the entrepreneur decides to spread the risk of an economic slowdown by diversifying her products between consumer and government buyers.

Process 500 also explores (525) various avenues of financing. Frequently, a client 200 depends entirely on private or corporate venture capital funding; she ignores other sources of capital. Thus, step 525 expands the investment pool to include institutional funding (e.g. government, insurance and pension funds), flexible mezzanine capital, debt and private capital from high net-worth individuals. By diversifying among financial vehicles, the entrepreneur gains more flexibility in her dealings.

Finally, process 500 distributes (530) responsibilities within the supply chain management in order to maximize economic return. In one embodiment, step 530 outsources the manufacturing to cheaper laborers. In another embodiment, step 530 identifies potential collaborators whose partnership would increase gross margins and expectations. Step 530 also evaluates whether each member of the supply chain profits from the production of the product. This analysis verifies that each participating party is provided with enough incentives. Thus, by distributing the risk, client 200 enhances the likelihood of survival for her potential products.

After the entrepreneur or intrapreneur has conceptualized (400) a portfolio of product(s) and properly distributed (500) the economic risk, process 600 envisions the organization that would be required to execute the new opportunity within the marketplace.

Successful execution of a new opportunity requires the implementation of various business processes, which are the necessary activities for running a business, e.g. advertising or supply chain management. Process 600 identifies (605) the necessary business processes for the new opportunity, and designs (610) organizational procedures that correspond to each business processes. A procedures is the sequence of actionable steps that together perform a particular business process. Qualified workers, which are identified by sub-process 615, implement these organizational procedures.

Sub-process 615 assigns (620) a required level of stewardship and skill for each organizational procedure. The required level of stewardship and skill serve as threshold tests for matching qualified workers. Stewardship refers to the character qualities for a particular worker, such as a sense of loyalty, a set of work-ethics, and a level of self-motivation. The skill may depend on the type of procedure, e.g. computer programming skills, accounting skills.

Sub-process 615 identifies (625) a list of workers within a selected geographic location, national or international. Each worker is interviewed (630) to determine their stewardship level and skill level. Sub-process 615 then matches (635) a worker with the requisite level of stewardship and skill with an appropriate procedure and adequate autonomy. The workers can then be compensated (640) according to level of stewardship, skill and autonomy.

The completion of processes 300, 400 and 500 results in a thoughtfully-considered and economically-viable new opportunity. Process 600 designs organizational procedures and assigns qualified works who would ultimately carry out this new opportunity in the selected marketplace. However, before the actual execution of the opportunity, the client 200 evaluates the entire process in order to mitigate any future risks.

Using process 700, the client 200 takes the proverbial “step back” and identifies (705) any anticipated obstacles, or roadblocks, for the future. Some examples include inadequate intellectual property protection; an inability to obtain technical talent; or a risk of litigation. In one embodiment, process 700 identifies (705) the future risks by using an innovation decisions map (IDM). The IDM highlights the key issues for each process and prompts the client 200 to consider any future obstacles.

Process 700 assigns (710) an innovation index to each obstacle based on the severity of the risk and its probability of occurrence. Each obstacle is prioritized (715) accordingly, thus allowing the client 200 to focus on resolving the most urgent risks. Client 200 may preemptively mitigate a future risk by taking present action, e.g. apply for more patents. She also may decide not to pursue a particular new opportunity due to a high level of severity or a high probability of occurrence. Once all future risks have been mitigated, the new opportunity is ready to be implemented in the marketplace.

In some embodiments, the innovation of process 600 is used by a business entity for evaluating a plurality of intellectual property assets. The business entity may be a for-profit organization that wishes to manage its intellectual property portfolio. The business entity also may be a non-profit organization. In another embodiment, a government entity, such as a policy-maker, uses the innovation index to evaluate how innovations affect a selected community.

For some embodiments, process 400, which conceptualizes the selected new opportunity 205, occurs simultaneously with sub-process 505, which retrieves the economic profile for a selected community. In another embodiment, sub-process 505 occurs before process 400, but after process 300, which selects a new opportunity 205. In yet another embodiment, client 200 may retrieve (505) the economic profiles for selected countries before selecting (300) a new opportunity 205.

The method steps of the application can be performed by one or more programmable processors executing a computer program to perform the functions of the processes of the system. The method steps can also be performed by, and the processes can be implemented as special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with client 200, the method of the invention can be implemented on a computer having a display device, e.g., a CRT (cathode ray tube) or LCD (liquid crystal display) monitor, for displaying information to the client and a keyboard and a pointing device, e.g., a mouse or a trackball, by which the client can provide input to the computer. Other kinds of devices can be used to provide for interaction with client 200 as well; for example, feedback provided to client 200 can be any form of sensory feedback, e.g., visual feedback, auditory feedback, or tactile feedback; and input from the client can be received in any form, including acoustic, speech, or tactile input.

The method of the invention can be implemented in a computing system that includes a back-end component, e.g., as a data server, or that includes a middleware component, e.g., an application server, or that includes a front-end component, e.g., a computer having a graphical user interface or a Web browser through which client 200 can interact with an implementation of the record extractor, or any combination of such back-end, middleware, or front-end components. The components of the system can be interconnected by any form or medium of digital data communication, e.g., a communication network. Examples of communication networks include a local area network (“LAN”) and a wide area network (WAN”), e.g., the Internet.

The computing system can include network clients and servers. A network client and server are generally remote from each other and typically interact through a communication network. The relationship of network clients and servers arises by virtue of computer programs running on respective computers and having a client-server relationship to each other.

The processes of the invention are not limited to the implementations set forth herein. For example, the steps of the processes can be rearranged and/or one or more such steps can be omitted to achieve similar results. The system may link to existing business models, thereby providing enhanced flexibility. The processes may be fully automated, meaning that they operate without user intervention, or interactive, meaning that all or part of each process includes some user intervention.

### EXAMPLE

In one example, client 200 is an innovator who wishes to formulate an innovation. Using process 600, the innovator discovers her innovative potential by taking a series of self-diagnostic exams. Some of the diagnostics measure her mental capacities, while others identify her expertise, networking alliances and assets. The results are complied in a client profile, which reveals, among many things, that the innovator excels in motivation, problem-solving, and verbal communication. The profile also highlights her areas of weakness, such as her impatience and inability to handle rejection. Based on these findings, she decides to take specific action in order to raise her critical awareness level in the sub-optimal areas.

In addition, the self-diagnostics identify an expertise in business and technology, namely in the field of mechanical components. Furthermore, the findings show that the innovator owns sophisticated equipment for plastic-injection-molding.

Process 600 also helps the innovator study the societal needs. In one exercise, she observes the habits and trends of consumers within a selected marketplace. Through this exploration, the innovator learns about several important trends. First, she notices that an increasing number of large corporations are delegating their component manufacturing to off-site locations. In addition, she notes that the marketplace still considers plastic an inferior material. However, it also prefers plastic as an inexpensive alternative to other materials, like steel and glass. Finally, the innovator observes the growing popularity of light as a tool for accurate measurements.

An exploration into the innovator's passions reveals an interest in the healthcare, communications, and safety industries. As a result, she studies the pre-existing products within these areas. For example, she observers how manufacturing services for polymer optics are conducted. She also studies the conventional methods for medical imaging and communications. Through these observations, she notices a growing trend within the military and healthcare industries in replacing safety equipment and medical devices with plastic materials. By drilling down in injection molding suppliers, she finds molding of polymer optics as a goods and services classification. Since this particular trend intersects with her innovation potential, the innovator decides to pursue manufacturing of high-end polymer optical components as an opportunity 205. In particular, she focuses on products, which cannot be outsourced to cheaper foreign laborers.

The innovator continues refining the scope of her new opportunity by exploring various institutional impacts. For example, a study of government institutions shows that surgical opportunities are highly litigated. As a result, the innovator decides not to pursue surgical devices. However, she also learns from studying government institutions that she can strategically position her opportunity to received Small Business Innovation Research (SBIR) funding. Thus, she decides to position her opportunity accordingly. From social institution, she learns to avoid using coating processes which are environmentally hazardous. She also considers various aesthetically appealing colors and trade dresses for the packaging and marketing of her products. After the client has undergone this rigorous and thorough process, the innovator finally selects a new opportunity.

The innovator then conceptualizes a portfolio of potential products. She begins by studying pre-existing products similar to the new opportunity. She determines which features contributed to the success of the particular product. For example, an important service feature of opto-electronic assembly is its unification yield. Thus, the innovator adopts a simplified version of this successful feature to manage her service. She also identifies high precision optics molding and machining as other successful service features. She improves upon these features by extending its available properties. By repeating this exercise of identifying and manipulating successful features, the innovator conceptualizes a portfolio of potential services.

Next, she sets about identifying the economic risks. She decides to pursue the United States as a potential market. To this end, she evaluates the economic profile for the country. She learns that the U.S. marketplace is experiencing an over-exuberance, which foreshadows a market slowdown in the near future. Since a slowdown would detrimentally affect the business investments and expenses, the innovator decides to diversify her opportunity and pursue two markets: consumer spending and government spending. Thus, she decides to provide manufacturing services of medical devices and defense industry tools. Furthermore, the potential for a market slowdown also affects the innovator's decision about capital funding. In this regard, she chose to use flexible mezzanine capital, since this type of capital is less constrained by a market slowdown.

The innovator continues identifying economic risks. The innovator also attempts to diversify responsibility by outsourcing the manufacturing of simply components to less expensive providers.

Finally, the innovator determines a set of business processes to implement the new opportunity. She designs corresponding organizational procedures, and then seeks qualified workers to carry out the tasks. The procedures include ineffective sales techniques, expensive manufacturing, and a need for quality control.

To implement these organizational procedures, the innovator assigns a level of requisite stewardship and skill to each procedure. Next, she identifies qualified workers within the selected geographic region of New York. She interviews each worker to assess stewardship qualities and skills; and matches each qualified candidate with a respective procedure. Compensation for the qualified workers may consist of stock options, which vest over time. The innovator also decides to structure bonuses in a manner that appropriately rewards and motivates the workers.

### EQUIVALENTS

The methods and systems described herein, are not limited to the specific formats set forth above. Elements of different implementations may be combined to form other implementations not specifically described above. Other implementations not specifically described herein, may be ascertain by those of skill in the art using no more than routine experimentation and are within the scope of the following claims.

What is claimed is:

1. A method for systematically generating and evaluating an innovation comprising:
(a) identifying and selecting an opportunity;
(b) conceptualizing the opportunity into a plurality of potential products;
(c) distributing an economic risk, the economic risk being associated with the opportunity; and
(d) envisioning an organization for introducing the potential products and pursuing the opportunity.

2. The method of claim 1 further comprising mitigating a future risk for the opportunity.

3. The method of claim 2, wherein mitigating the future risk comprises:
identifying a future risk;
assigning an innovation index number to the future risk;
prioritizing the future risk into a priority order, the priority order being allocated according to the innovation index number; and
resolving each future risk according to the priority order.

4. The method of claim 3, wherein the innovation index number is used by a business entity for evaluating a plurality of intellectual property assets.

5. The method of claim 3, wherein the innovation index is used by a policy-making entity for evaluating an economic health for a selected community.

6. The method of claim 1, wherein the potential product is a good or a service.

7. The method of claim 1, wherein the opportunity comprises an unexplored opportunity in a marketplace.

8. The method of claim 7, wherein the marketplace is a selected community, a selected state, or a selected community.

9. The method of claim 1, wherein step (a) comprises the steps of:
identifying a plurality of innovative dispositions of a client thereby generating a client profile, the innovative dispositions comprising a plurality of innovative strengths and a plurality of innovative weaknesses;
identifying a plurality of institutional influences;
identifying a plurality of societal needs; and
comparing the identified societal needs with the client profile;
wherein the specific societal need that matches the greatest number of innovative strengths and least number of negative institutional influences is indicative of opportunity.

10. The method of claim 9, wherein identifying the societal needs further comprises aggregating a plurality of sectors;
wherein the sectors are selected from a group consisting of food, shelter, clothing, education, entertainment/communications, transportation, energy, healthcare, safety, hope, relationship and money.

11. The method of claim 1, wherein step (b) comprises the steps of:
generating the potential product and a corresponding competitive comparison;
prioritizing the potential product in a production order, the production order being a sequential ranking of when the potential product is introduced to the market; and
protecting an intellectual property right of the potential product.

12. The method of claim 11, wherein generating the potential product comprises the steps of:
generating a successful feature list;
manipulating the successful feature into an unique feature;
applying the unique feature to an identified opportunity; and
generating a potential product.

13. The method of claim 12, wherein manipulating the successful feature into the unique feature comprises the steps of:
combining a plurality of successful features to generate the unique feature;
generating a simplified version of the successful feature;
generating a smaller version of the successful feature;
transferring existing features with no change;
adding an improvement to the successful feature;
lowering an expense associated with the pre-existing product; and
ensuring that the unique feature and successful feature share a foothold with a consumer.

14. The method of claim 1, wherein step (c) comprises the steps of:
evaluating a plurality of economic risks within a selected community;
diversifying a plurality of economic components;
exploring a plurality of financial vehicles; and
distributing a plurality of economic responsibilities.

15. The method of claim 1, wherein step (d) comprises the step of:
identifying a business process for generating a revenue and managing a cost;
generating the organizational procedures that corresponds to the business process;
assigning a worker to implement the organizational procedures.

16. The method of claim 1 further comprising reorienting the opportunity.

17. A method for identifying and selecting an opportunity, the method comprising:
(a) identifying a plurality of innovative dispositions of a client thereby generating a client profile, the innovative dispositions comprising a plurality of innovative strengths and a plurality of innovative weaknesses;
(b) identifying a plurality of institutional influences;
(c) identifying a plurality of societal needs; and
(d) comparing the identified societal needs with the client profile;
wherein the specific societal need that matches the greatest number of innovative strengths and least number of negative institutional influences is indicative of an new opportunity.

18. The method of claim 17, wherein step (c) comprises the steps of:
analyzing sectors, the sectors being associated with the societal need;
selecting an unexplored opportunity within the sector; and
determining a probability of success for the unexplored opportunity in the marketplace.

19. The method of claim 17 which is performed using a computer.

20. The method of claim 17, wherein the societal need is customized according to a demographic.

21. The method of claim 17, wherein the client is an individual.

22. The method of claim 17, wherein the client is an organization.

23. The method of claim 17, wherein the client is an investor.

24. A method for conceptualizing an identified opportunity into a plurality of potential products, the method comprising:
generating the potential product and a corresponding competitive comparison;
prioritizing the potential products in a production order, the production order being a sequential ranking of when the potential product is introduced; and
protecting an intellectual property right of the potential product.

25. The method of claim 24, wherein generating the potential product comprises the steps of:
(a) generating a successful features list;
(b) manipulating the successful features into an unique feature;
(c) applying the unique feature to an new opportunity; and
(d) generating the potential product and the corresponding competitive comparison.

26. The method of claim 25, wherein step (a) comprises the steps of:
identifying a plurality of related pre-existing products;
examining the related pre-existing product for successful features; and
adding the successful features to the features list.

27. The method of claim 25, wherein step (b) comprises the steps of:
combining several successful features to generate an unique feature;
generating a simplified version of the successful feature;
generating a smaller version of the successful feature;
adding an improvement to the successful feature;
lowering an expense associated with the pre-existing product; and
ensuring that the unique feature and successful feature share a foothold with a consumer.

28. The method of claim 27, wherein an improvement is a feature that enhances the performance of the related pre-existing product.

29. A method for distributing an economic risk, the method comprising:
(a) identifying the economic risk for a selected community, the identifying comprising:
(i) selecting a country for marketing a plurality of potential products, the potential products being associated with the opportunity;
(ii) retrieving an economic profile for the selected community from an external database;
(iii) comparing the potential products with the economic profile for the selected community;
(iv) identifying the economic risk for the selected community;
(b) diversifying a plurality of economic components;
(c) exploring a plurality of financial funding; and
(d) distributing a plurality of responsibilities.

30. The method of claim 29, wherein the economic profile comprises information regarding a macro-economic environment for the selected community.

31. A method for envisioning the organization that would execute the opportunity, the method comprising:
(a) identifying a business process for generating a revenue and managing a cost;
(b) generating the organizational procedures that corresponds to the business process;
(c) assigning a qualified worker to implement the organizational procedures.

32. The method of 31, wherein step (c) comprises the steps of:
identifying a plurality of potential workers within a particular geographical location;
assigning a required level of stewardship and skill for each organization procedure;
interviewing each potential worker to determine a level of stewardship and skill;
matching the qualified worker to each organization procedure based on a comparison between the level of stewardship and skill and the required level of stewardship, skill and autonomy;
assigning a compensation to the qualified worker, the compensation being commensurate to the level of stewardship, skill, and autonomy of the qualified worker.

33. The method of 32, wherein the level of stewardship measures a plurality of positive character traits associated with a workplace environment.

34. A computer program product, tangibly embodied in an information carrier, the computer program product being operable to cause a data processing apparatus, in a network of interconnected computers to:
(a) identify and select an opportunity;
(b) conceptualize the opportunity into a plurality of potential products;
(c) distribute an economic risk, the economic risk being associated with the opportunity; and
(d) envision an organization for introducing the potential products and pursuing the opportunity.

35. The computer program of claim 34 further comprising mitigating a future risk for the opportunity.

36. The computer program of claim 35, wherein mitigating the future risk comprises:
identifying a future risk;
assigning an innovation index number to the future risk;
prioritizing the future risk into a priority order, the priority order being allocated according to the innovation index number; and
resolving each future risk according to the priority order.

37. The computer program of claim 36, wherein the innovation index number is used by a business entity for evaluating a plurality of intellectual property assets.

38. The computer program of claim 37, wherein the innovation index is used by a policy-making entity for evaluating an economic health for a selected community.

39. The computer program of claim 34, wherein step (a) comprises the steps of:
identifying a plurality of innovative dispositions of a client thereby generating a client profile, the innovative dispositions comprising a plurality of innovative strengths and a plurality of innovative weaknesses;
identifying a plurality of institutional influences;
identifying a plurality of societal needs; and
comparing the identified societal needs with the client profile;
wherein the specific societal need that matches the greatest number of innovative strengths and least number of negative institutional influences is indicative of opportunity.

40. The computer program of claim 34, wherein step (b) comprises the steps of:
generating the potential product and a corresponding competitive comparison;
prioritizing the potential product in a production order, the production order being a sequential ranking of when the potential product is introduced to the market; and
protecting an intellectual property right of the potential product.

41. The computer program of claim 40, wherein generating the potential product comprises the steps of:
generating a successful feature list;
manipulating the successful feature into an unique feature;
applying the unique feature to an identified opportunity; and
generating the potential product and the corresponding competitive comparison.

42. The computer program of claim 41, wherein manipulating the successful feature into the unique feature comprises the steps of:
combining a plurality of successful features to generate the unique feature;
generating a simplified version of the successful feature;
generating a smaller version of the successful feature;
transferring existing features with no change;
adding an improvement to the successful feature;
lowering an expense associated with the pre-existing product; and
ensuring that the unique feature and successful feature share a foothold with a consumer.

43. The computer program of claim 34, wherein step (c) comprises the steps of:
evaluating a plurality of economic risks within a country, a state, or a community;
diversifying a plurality of economic components;
exploring a plurality of financial vehicles; and
distributing a plurality of economic responsibilities.

44. The computer program of claim 34, wherein step (d) comprises the step of:
identifying a business process for generating a revenue and managing a cost;
generating the organizational procedures that corresponds to the business process;
assigning a worker to implement the organizational procedures.

45. The computer program of claim 34 further comprising reorienting the opportunity.

46. An apparatus for systematically generating and evaluating an innovation, the apparatus comprising a system providing:
(a) means for identifying and means for selecting an opportunity;
(b) means for conceptualizing the opportunity into a plurality of potential products;
(c) means for distributing an economic risk, the economic risk being associated with the opportunity; and
(d) means for envisioning an organization for introducing the potential products and pursuing the opportunity.

47. The apparatus of claim 46 further comprising mitigating a future risk for the opportunity.

48. The apparatus of claim 47, wherein mitigating the future risk comprises:
identifying a future risk;
assigning an innovation index number to the future risk;
prioritizing the future risk into a priority order, the priority order being allocated according to the innovation index number; and
resolving each future risk according to the priority order.

49. The apparatus of claim 48, wherein the innovation index number is used by a business entity for evaluating a plurality of intellectual property assets.

50. The apparatus of claim 49, wherein the innovation index is used by a policy-making entity for evaluating an impact of the opportunity on a selected community.

51. The apparatus of claim 46, wherein the potential product is a good or a service.

52. The apparatus of claim 46, wherein step (a) comprises the steps of:
identifying a plurality of innovative dispositions of a client thereby generating a client profile, the innovative dispositions comprising a plurality of innovative strengths and a plurality of innovative weaknesses;
identifying a plurality of institutional influences;
identifying a plurality of societal needs; and
comparing the identified societal needs with the client profile;
wherein the specific societal need that matches the greatest number of innovative strengths and least number of negative institutional influences is indicative of opportunity.

53. The apparatus of claim 46, wherein step (b) comprises the steps of:
generating the potential product and a corresponding competitive comparison;
prioritizing the potential product in a production order, the production order being a sequential ranking of when the potential product is introduced to the market; and
protecting an intellectual property right of the potential product.

54. The apparatus of claim 53, wherein generating the potential product comprises the steps of:
generating a successful feature list;
manipulating the successful feature into an unique feature;
applying the unique feature to an identified opportunity; and
generating the potential product and the corresponding competitive comparison.

55. The apparatus of claim 54, wherein manipulating the successful feature into the unique feature comprises the steps of:
combining a plurality of successful features to generate the unique feature;
generating a simplified version of the successful feature;
generating a smaller version of the successful feature;
transferring existing features with no change;
adding an improvement to the successful feature;
lowering an expense associated with the pre-existing product; and
ensuring that the unique feature and successful feature share a foothold with a consumer.

56. The apparatus of claim 46, wherein step (c) comprises the steps of:
evaluating a plurality of risks within a selected community;
diversifying a plurality of economic components;
exploring a plurality of financial vehicles; and
distributing a plurality of economic responsibilities.

57. The apparatus of claim 46, wherein step (d) comprises the step of:
identifying a business process for generating a revenue and managing a cost;
generating the organizational procedures that corresponds to the business process;
assigning a worker to implement the organizational procedures.

58. The apparatus of claim 46 further comprising reorienting the opportunity.

59. The method of claim 17, wherein the identifying the plurality of innovative dispositions comprises:
administering personal diagnostics, the personal diagnostics being used to test a level of critical awareness.

60. The method of claim 59, wherein the level of critical awareness is selected from a group consisting of ethics, physical action, analytical reasoning, creative imagination, emotion, memory, motivation, perception and sensation.
